(19) United States
(12) Patent Application Publication
(10) Pub. No.: US 2019/0325038 A1
(43) Pub. Date: Oct. 24, 2019

(54) CONSENSUS BASED EDITABLE BLOCKCHAIN

(71) Applicant: Keir Finlow-Bates, Kangasala (FI)

(72) Inventor: Keir Finlow-Bates, Kangasala (FI)

(21) Appl. No.: 15/959,172

(22) Filed: Apr. 21, 2018

(51) Int. Cl. G06F 17/30; H04L 9/06; H04L 29/06

(52) U.S. Cl. CPC G06F 17/30117; H04L 9/0643; H04L 2209/38; H04L 63/0428; G06F 17/30283; H04L 9/0637

(57) ABSTRACT

A system and method for an editable blockchain is presented. Blocks within the blockchain are constructed in a manner that ensures that a data payload within the block is not included in a hash of the block, however, a hash of the data payload is included. Subsequently, a publisher of the data payload may make a request over the blockchain for the data payload to be deleted. The request may comprise a reason for a requirement to delete. Participants on the blockchain may then select to delete the data payload or overwrite the data payload with random data or zeros, such that a data of the data payload is effectively removed. As a result, the onus for a removal of the data is shifted from the publisher of the data payload to the participants on the blockchain, and an integrity of the hash-linked chain of blocks is maintained.

### TECHNICAL FIELD

This disclosure relates to computer systems and methods concerned with the storage and deletion of computer data, and more specifically to the storage and subsequent deletion of data on a blockchain.

### BACKGROUND

Distributed ledgers provided in, for example, a peer-to-peer network, such as the distributed ledger used in the Bitcoin cryptocurrency system, allow for an immutable ledger of data. Such a system is known to those skilled in the art as a blockchain.

Blockchains are of interest to industries such as finance, banking, gambling, gaming, media, publishing, stock trading, logistics, shipping, internet of things cloud platform providers, and venture funding, as a blockchain may be used to create a permanent record of digital data, without requiring a centralized database or other data store and an associated company or organization to manage said centralized database or other data store.

A significant benefit of blockchains is that they are tamper proof and immutable, that is, data stored on a blockchain may not be edited or removed without participants on the blockchain being able to detect such attempts at change or deletion. Participants may subsequently reject any unacceptable changes.

However, blockchains have a number of problems. Due to an immutable nature of a blockchain combined with a plurality of blockchain maintainers, a blockchain may be unable to comply with legal demands to correct inaccurate date, or remove data on request. For example, under a European General Data Protection Regulation (GDPR), an organization that does not delete personal data at a request from a European citizen may face severe financial penalties.

A method for editing data on a blockchain is known from U.S. Pat. No. 9,774,578, wherein a chameleon hash is used, such that a secret key may allow rewriting of specific blockchain blocks and re-computation of block hashes. However, the method requires a central authority to hold and utilize the secret key. Changes to the blockchain may therefore not be apparent, and a core feature of blockchains, namely decentralization, is lost.

It is therefore the intention of the present disclosure to address the problem of deleting data on a blockchain in a transparent, decentralized and consensus-building manner.

### SUMMARY

In accordance with the present disclosure, a solution is provided for submitting and subsequently deleting data from a blockchain or other immutable ledger.

Blockchain validators, comprising, in a preferred embodiment of the present disclosure, a plurality of network connected devices participating in maintaining and extending the blockchain, may receive data and messages over a peer-to-peer network, which they may package into a data block for potential inclusion in the blockchain. The data block may comprise a one or more data payloads. If the validators deem a data block to be valid, that is, it complies with protocols and rules of the blockchain, the validators may add the data block to the blockchain.

In a preferred embodiment, a plurality of network connected devices, each comprising: one or more processors, and storage media comprising computer instructions, said plurality of network connected devices being connectible via a network to each other, arranged such that when computer instructions are executed on the one or more processors of a one or more of the plurality of network connected devices, operations are caused for adding and subsequently deleting data from a blockchain.

In the preferred embodiment, operations may commence by a one or more network connected devices submitting a one or more data payloads to the blockchain.

Subsequently a first of the plurality of network connected devices may construct a block of data for the blockchain comprising: a first portion of the block of data comprising a list of hashes of a one or more data payloads, a second portion of the block of data comprising the one or more data payloads, a hash of a first portion of a prior block of data for the blockchain.

The first of the plurality of network connected devices may then submit the block of data to the blockchain for inclusion on the blockchain.

The plurality of network connected devices may then include the block of data in the blockchain.

At a later time, a second network connected device may transmit a request to delete a one or more of the one or more data payloads from the blockchain.

The request to delete may be included in a block of data for the blockchain, by a network connected device, and may subsequently be included in the blockchain by the plurality of network connected devices.

In an embodiment the plurality of network connected devices may then examine the request to delete, and may subsequently delete the one or more of the one or more data payloads specified in the request to delete from the blockchain.

In an alternate embodiment the plurality of network connected devices may delete the one or more of the one or more data payloads from the blockchain by overwriting the one or more of the one or more data payloads with zeros.

In yet another embodiment the plurality of network connected devices may delete the one or more of the one or more data payloads from the blockchain by overwriting the one or more of the one or more data payloads with random data.

In a different embodiment the plurality of network connected devices may delete the one or more of the one or more data payloads from the blockchain by overwriting the one or more of the one or more data payloads with a deletion message. The deletion message may comprise: the request to delete, a reference to the request to delete, information relating to the second of the plurality of network connected devices such as: an identity, an IP address, an email address, a bank account number, a cryptocurrency address of the second of the plurality of network connected devices.

Those skilled in the art will appreciate that an other data may be used in overwriting the one or more of the one or more data payloads, said other data comprising different combinations of messages and values.

In a further embodiment of the present disclosure, a one or more of the plurality of network connected devices may each submit, to the blockchain, an endorsement of the request to delete. A one or more endorsements may be included in a data block, and subsequently included in the blockchain.

In some embodiments endorsements may comprise messages or transactions sent to the blockchain. In other embodiments endorsements may comprise an execution of a smart contract and subsequent recording by the smart contract of the endorsement. The request to delete may comprise the smart contract, or the smart contract may be deployed separately.

In some embodiments the smart contract may be deployed with the data payload.

In some embodiments, the plurality of network connected devices may verify the one or more endorsements from the blockchain, and subsequently count a number of verified endorsements.

In another embodiment the one or more endorsements may be verified and counted by the smart contract.

If the number of verified endorsements of the request to delete is equal to or greater than a predetermined number, the plurality of network connected devices may then delete the one or more of the one or more data payloads from the blockchain.

In an embodiment, the predetermined number may comprise a percentage of a total number of the plurality of network connected devices. In another embodiment, the predetermined number may comprise a fixed value. In an alternate embodiment, the predetermined number may comprise a value proportional to a number of blocks generated and included on the blockchain between a data block comprising a data payload to be deleted, and a data block comprising the request to delete.

In another embodiment, the predetermined number may be proportional, inversely or otherwise, to a quantity of tokens offered along with the request to delete.

In some embodiments, the plurality of network connected devices may forgo endorsing a request to delete if it is determined that the second of the plurality of network connected devices is not an authorized entity. In some embodiments, the authorized entity may comprise the first of the plurality of network connected devices, namely a submitter of the data payload.

In an alternate embodiment, the second of the plurality of network connected devices may attain a status of authorized entity by submitting the request to delete along with a quantity of tokens, in effect paying for a right to the status of authorized entity.

In some embodiments the tokens may be a native cryptocurrency of the blockchain. In other embodiments the tokens may be instantiated by a smart contract. For example, on an Ethereum blockchain the smart contract may comprise an ERC20 standard smart contract, or some other standard smart contract.

In an embodiment, the second of the network connected devices may associate the request to delete with a quantity of tokens, such that a portion of said quantity of tokens may be claimed by each of the plurality of network connected devices on submitting an endorsement of the request to delete. The embodiment may be instantiated in a smart contract.

In an alternate embodiment, the second of the network connected devices may associate the request to delete with a quantity of tokens, such that a portion of said quantity of tokens may claimed by each of the plurality of network connected devices on deleting, from the blockchain, the one or more of the one or more data payloads. The alternate embodiment may be instantiated in a smart contract.

Through these various embodiments detailed above, a blockchain may be instantiated in which a data may be submitted for inclusion on the blockchain, and subsequently the data may be deleted from the blockchain, without requiring a central authority or by ceding additional rights or powers to specific participants on the blockchain.

Those skilled in the art will further appreciate the advantages and superior features found in this disclosure together with other important aspects thereof on reading the detailed description that follows in conjunction with the drawings.

### BRIEF DESCRIPTION OF THE DRAWINGS

The components in the figures are not necessarily to scale, emphasis instead being placed upon illustrating the principles of the present disclosure. In the figures, like reference numerals designate corresponding parts throughout the different views.

FIG. 1 illustrates a peer-to-peer network with a plurality of network connected devices connected to the peer-to-peer network, performing the roles of a validator, a data submitter, a deletion requester, and a communication node, and other network connected devices, maintaining and extending a blockchain, in accordance with an embodiment of the present disclosure.

FIG. 2 illustrates a network connected device and associated components, in accordance with an embodiment of the present disclosure.

FIG. 3 is a block diagram illustrating a structure of a data block, in accordance with an embodiment of the present disclosure.

FIG. 4 is a block diagram illustrating a subsection of the blockchain comprising a number of hash-linked blocks, in accordance with an embodiment of the present disclosure.

FIG. 5 is a flow diagram illustrating a method for constructing a data block, in accordance with an embodiment of the present disclosure.

FIG. 6 is a block diagram illustrating a structure of a request to delete, in accordance with an embodiment of the present disclosure.

FIG. 7 is a diagram providing a general overview of a method for deleting a data payload in response to the request to delete, in accordance with an embodiment of the present disclosure.

FIG. 8 is a diagram presenting a process and system for endorsing the request to delete, in accordance with an embodiment of the present disclosure.

FIG. 9A is a block diagram presenting a structure of a request to delete associated with a quantity of tokens through a token transfer transaction, in accordance with an embodiment of the present disclosure.

FIG. 9B is a block diagram presenting a structure of a request to delete associated with a quantity of tokens through a smart contract, in accordance with an embodiment of the present disclosure.

FIG. 10 is a diagram presenting a process for transferring a portion of the quantity of tokens associated with a request to delete, to an endorser, in accordance with an embodiment of the present disclosure.

FIG. 11 is a diagram presenting a process for transferring a portion of the quantity of tokens associated with a request to delete, to a deleter, in accordance with an embodiment of the present disclosure.

### DETAILED DESCRIPTION

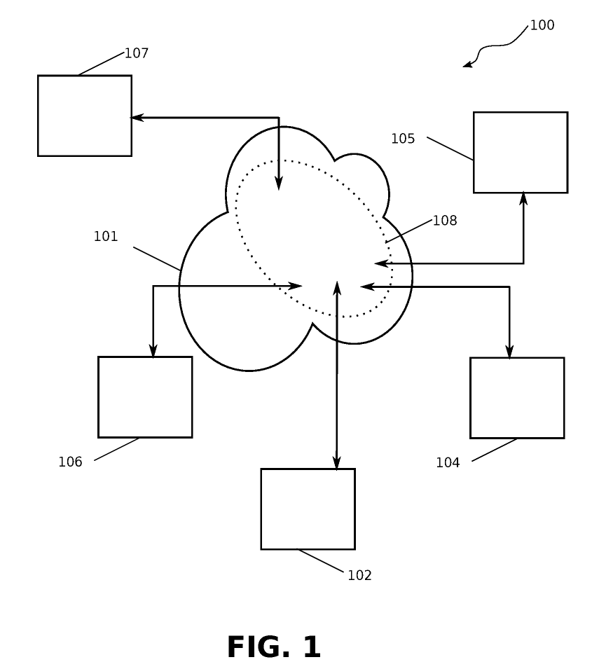

Aspects of this disclosure will be described in the context of an exemplary system of a plurality of network connected devices communicating through the medium of a peer-to-peer network system 100, thereby implementing a blockchain, as shown schematically in FIG. 1.

As depicted, a peer-to-peer network 108 is embodied within a packet switched network 101, through the interconnection of the plurality of network connected devices on the peer-to-peer network 108.

Devices connected to the peer-to-peer network 108 may include data generators, for example a network connected device 102, that may generate data. Such a network connected device 102 may embody a data generator.

Other devices connected to the peer-to-peer network 108 may include network connected devices acting as communication nodes, for example network connected device 104 whose role is to maintain a list of other devices connected through the peer-to-peer network, and to forward on received network messages to those devices on the list, possibly independently, or possibly as a response to a request from another network connected device. Such a network connected device 104 may embody a communication node. As one skilled in the art will be aware, no individual communication node is required to have a complete list of all devices, as the process of peer-to-peer networking only requires that a union of a set of all communication nodes contains a complete list of all devices on the peer-to-peer network, and for every pair of network connected devices there is a network route from one device to the other, possibly via a set of one or more nodes. Therefore, an only requirement to be a participant on the peer-to-peer network is to establish a connection to one or more of the communication nodes on said network.

Further devices connected via the peer-to-peer network 108 may include blockchain validators, for example network connected device 105, acting as a validator or “miner”, whose role may be to act as a communication node, and may also be to receive messages, records and other transaction or data messages from the peer-to-peer network 108, process them, and transmit the results of said processing back to the peer-to-peer network 108 for potential inclusion in the blockchain. Such a network connected device 105 may embody a validator. In an embodiment the validator may process data messages into a block for inclusion on the blockchain.

Further devices connected via the peer-to-peer network may include deleters, for example a network connected device 107, that may submit a request to delete data generated by data generators and included on the blockchain by validators. Such a network connected device 107 may embody a deleter. In some embodiments the data generator 102 and the deleter 107 may be embodied in a same network connected device.

Further devices connected via the peer-to-peer network may include endorsers, for example a network connected device 106, that may perform a role of endorsing the request to delete. In some embodiments the endorser may be embodied in any of an above mentioned network connected device.

The devices described above may be implemented through a system comprising a one or a plurality of: a general purpose microprocessor, a digital signal processor (DSP), an application specific instruction set processor (ASIP), a field programmable gate array (FPGA), a dedicated application specific integrated chip (ASIC), or other equivalent integrated or discrete logic circuitry and peripheral circuitry, connected to a tangible storage medium containing instructions which when executed effect methods and techniques described below. The techniques additionally, or alternatively, may be realized at least in part by a computer-readable communication medium or record carrier, that carries or communicates code in the form of instructions or data structures and that can be accessed, read, and/or executed by a computer.

The devices described above may connect to the peer-to-peer network 108 through a direct connection to the packet switched network 101 with a wired connection, or through a wireless connection by association with a wireless access point, a cellular base station, a Bluetooth connection, or other means of connection.

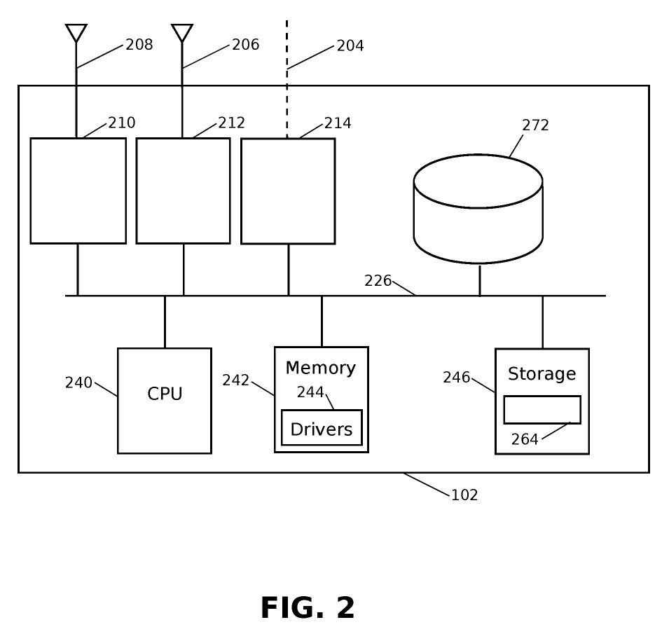

An embodiment of a network connected device 102 is presented in FIG. 2, and is now discussed in further detail. The network connected device 102 may comprise a one or more central processing units (CPU) 240 capable of executing instructions stored in a memory 242, and controlling other peripheral components through drivers 244 stored within the memory 242.

Further storage 246 may be present, which may comprise a cryptographically secure partition 264 or other component where cryptographic keys may be securely stored.

The network connected device 102 may comprise a network module 214, which may consist of a direct wired connection to a packet switched network through a cable 204.

The network connected device 102 may comprise a wireless network module 212, which may comprise wireless components comprising one or more wireless modules implemented in firmware or hardware, for example, a wireless local area network (WLAN) unit such as a Wi-Fi adapter utilizing an 802.11 protocol, a wireless wide area network (WWAN) unit such as Global System for Mobile communications (GSM), Long Term Evolution (LTE), or other cellular wireless data communication system. The wireless network module may comprise an antenna 206. The wireless components may provide network connectivity to a packet switched network and hence to the peer-to-peer network for the network connected device 102.

The network connected device 102 may comprise a Bluetooth network module 210, which may comprise wireless components comprising one or more Bluetooth modules implemented in firmware or hardware. The Bluetooth network module 210 may comprise an antenna 208. The Bluetooth components may provide network connectivity to a packet switched network and hence to the peer-to-peer network for the network connected device 102.

Components comprising the network connected device 102 may communicate through a bus 226, which may be implemented as a peripheral component interconnect express (PCIe) bus, a universal serial bus (USB), a universal asynchronous receiver/transmitter (UART) serial bus, a suitable advanced micro-controller bus architecture (AMBA) interface, a serial digital input output (SDIO) bus, or other equivalent interface.

The network connected device 102 may comprise a database 272. The database 272 may be instantiated internally to the network connected device 102, or it may comprise an instantiation on a separate device or machine communicated to through an external connection and an interface within the network connected device. The external connection may be a cable to a packet-switched network, either on a local area network or wide area network, an external serial connection, or through a wireless connection by association with a wireless access point, a cellular base station, a Bluetooth connection, or other means of connection.

Other network connected devices 104, 105, 106, 107, may be embodied in an identical or similar manner to the network connected device 102. A network connected device may comprise all or some of functionalities of an aforementioned network connected devices, namely: data generator, communication node, validator, deleter and endorser.

In the current disclosure a various network connected devices may communicate over a blockchain through a use of messages submitted to, included in, and subsequently read from the blockchain. The various network connected devices may also communicate through an instantiation of a one or more smart contracts on the blockchain, and subsequent execution of the one or more smart contracts.

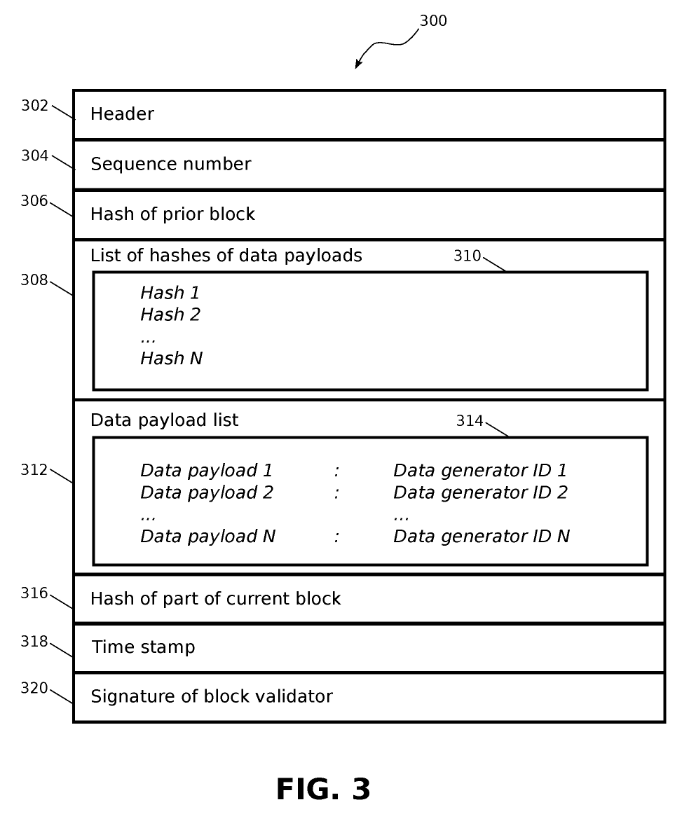

In FIG. 3 an embodiment of a block 300 is presented, through which data obtained or processed by the network connected device 102, henceforth referred to as a data generator, may be packaged and included on the blockchain by a validator, for example network connected device 105.

The block 300 may comprise a header 302, which may comprise: an identifier indicating that the block 300 contains a data, a size of the data, a protocol for the data, a structure of the data.

The block 300 may comprise a sequence number 304, which may indicate where in a sequence of blocks the block 300 is positioned.

The block 300 may comprise a hash of a prior block 306. The hash may be calculated from a part or all of the prior block using a cryptographic hash algorithm, for example: SHA, RIPEMD, Whirlpool, Scrypt, HAS-160, BLAKE, or other cryptographic hash function, where a hash output cannot be determined from a hash input other than by an application of the cryptographic hash function to the hash input.

The block 300 may comprise a list of hashes of data payloads 308. The list of hashes of data payloads 308 may comprise a one or more hashes 310, with each of the one or more hashes 310 corresponding to a data payload. Each of the one or more hashes 310 may be calculated from a corresponding data payload using a cryptographic hash algorithm, for example: SHA, RIPEMD, Whirlpool, Scrypt, HAS-160, BLAKE, or other cryptographic hash function.

The block 300 may comprise a data payload list 312. The data payload list 312 may comprise a one or more data payloads. In a preferred embodiment, the data payload list 312 may comprise a list of tuples 314, with each tuple comprising a data payload and an identifier of a data generator responsible for or owning the data payload.

In some embodiments a hash in the list of hashes of data payloads 308 may be generated from a corresponding data payload. For example, in FIG. 3, Hash 1 may be generated from Data payload 1.

In other embodiments, a hash in the list of hashes of data payloads 308 may be generated from a corresponding tuple in the data payload list 312. For example, in FIG. 3, Hash 1 may be generated from Data payload 1 and Data generator ID 1.

In some embodiments, a data generator identifier, such as Data generator ID 1, may comprise: a public key from a public/private key pair, an identification number, an email address, an IP address.

The block 300 may comprise a hash 316 of the block 300. The hash may be calculated from a part or all of the block 300 using a cryptographic hash algorithm, for example: SHA, RIPEMD, Whirlpool, Scrypt, HAS-160, BLAKE, or other cryptographic hash function, where a hash output cannot be determined from a hash input other than by an application of the cryptographic hash function to the hash input. In a preferred embodiment the hash 316 may be calculated from the header 302, the sequence number 304, the hash of the prior block 306 and the list of hashes of the data payloads 308.

In an embodiment the hash 316 may be calculated from the header 302, the sequence number 304, the hash of the prior block 306 and a one or more of the hashes of the data payloads 310. Those skilled in the art will appreciate that in an embodiment, under the current disclosure a data payload associated with a hash not included in the one or more of the hashes of the data payloads may correspond with a data payload that may subsequently be deleted. In an alternate embodiment the data payload may subsequently not be deleted.

The block 300 may comprise a time stamp 318. In an embodiment the time stamp may comprise a time at which the block was generated. The block 300 may also comprise a plurality of time stamps.

The block 300 may also comprise a digital signature 320, generated with a digital signature algorithm using a private key associated with a public key and the hash 316 of part of the block 300, in order to provide for a veracity of the block 300. The digital signature algorithm used may be one of ECDSA, DSA, RSA, or some other digital signing algorithm.

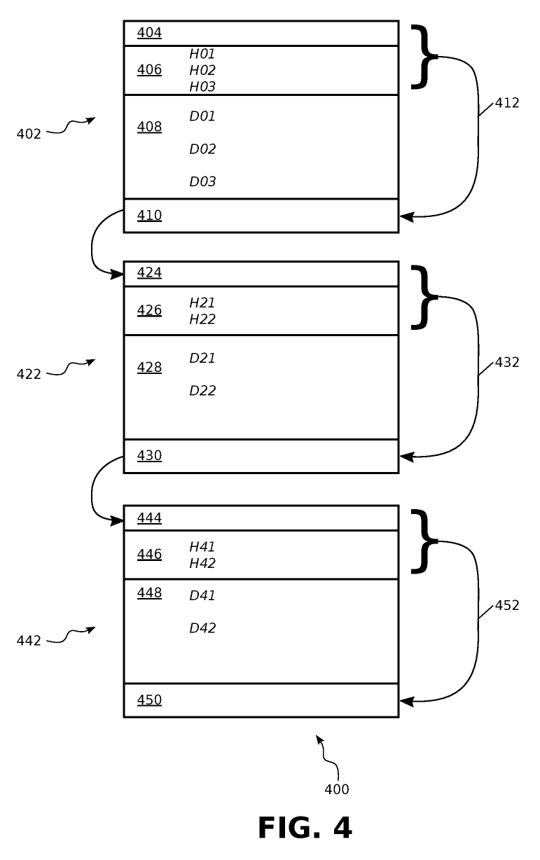

In FIG. 4, a block diagram is presented, illustrating how a hash-linked list of blocks may embody an aspect of the current disclosure.

A subsection of a blockchain 400 may comprise a number of consecutive blocks. A first block 402 of the subsection of the blockchain 400 may comprise a first header 404, a first list of hashes of data payloads 406, a first list of data payloads 408, and a first hash 410. For a purpose of illustration we limit a description of blocks comprising the hash-linked list to an aforementioned components, but those skilled in the art will appreciate that blocks within the blockchain may comprise other components and may forgo a one or more of a described components. Furthermore, the described components may comprise other elements.

A second block 422 of the subsection of the blockchain 400 may comprise a second header 424, a second list of hashes of data payloads 426, a second list of data payloads 428, and a second hash 430.

A third block 442 of the subsection of the blockchain 400 may comprise a third header 444, a third list of hashes of data payloads 446, a third list of data payloads 448, and a third hash 450.

The first hash 410 may be generated from the first header 404 and the first list of hashes of data payloads 406, as shown by 412.

The second header 424 may comprise the first hash 410. The second hash 430 may be generated from the second header 424 and the second list of hashes of data payloads 426, as shown by 432.

The third header 444 may comprise the second hash 430. The third hash 450 may be generated from the third header 444 and the third list of hashes of data payloads 446, as shown by 452.

Those skilled in the art will appreciate that through the disclosure above the third block 442 may be hash-linked to the second block 422, and the second block 422 may be hash-linked to the first block 402. A hash-linkage of the number of consecutive blocks may therefore be established. If a data payload is altered, the hash-linkage of the number of consecutive blocks is maintained. Alteration of the data payload may be detected by computing a hash of the data payload and comparing the hash of the data payload with a corresponding hash in a list of hashes.

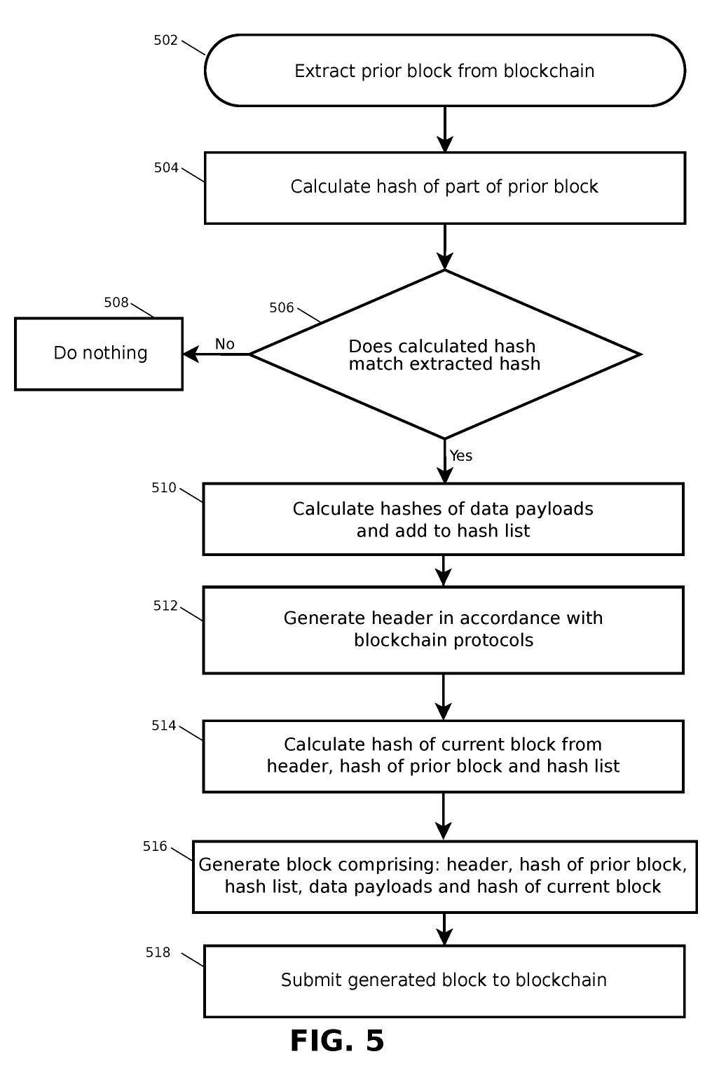

A flow diagram illustrating a method for constructing a block for inclusion in the blockchain is presented in FIG. 5.

In some embodiments of the present disclosure, operations may commence by extracting a prior block from the blockchain, as shown in step 502.

Operations may continue by computing a calculated hash of a part of the prior block, as shown in step 504. In accordance with an agreed standard for the blockchain, in one embodiment the calculated hash may be computed from the part of the prior block comprising a header, a sequence number of the prior block, a hash of a block prior to the prior block, a list of hashes of data payloads contained within the prior block, a time stamp of the prior block, a signature of a generator of the prior block, a one or more transactions included within the prior block.

The calculated hash may then be compared with a extracted hash obtained from the prior block, as shown in step 506.

If the extracted hash and the calculated hash are not the same, operations may proceed to step 508, and halt. In an alternate embodiment a new prior block may be retrieved from the blockchain and operations may recommence from step 502.

If the extracted hash and the calculated hash are the same, operations may proceed to step 510, and a hash list may be constructed, comprising a one or more hashes calculated from a one or more data payloads. In another embodiment the block may comprise no data payloads and no hash list may be constructed.

Operations may then proceed to step 512, wherein a header may be constructed in accordance with the blockchain protocols. The header may comprise: an identifier indicating that the block contains a data, a size of the data, a protocol for the data, a structure of the data, a sequence number.

Operations may then proceed to step 514, wherein a current block hash is calculated for the block. The current block hash may be calculated using a cryptographic hash algorithm, for example: SHA, RIPEMD, Whirlpool, Scrypt, HAS-160, BLAKE, or other cryptographic hash function, applied to data comprising the header, the hash of the prior block, and the hash list.

Operations may then proceed to step 516, wherein a block is generated comprising: the header, the hash of the prior block, the hash list, a list of data payloads, and the current block hash. In other embodiments, the block may also comprise a time stamp, other transactions, and other data.

Operations may then proceed to step 518, wherein the block is submitted to the peer-to-peer network for inclusion on the blockchain.

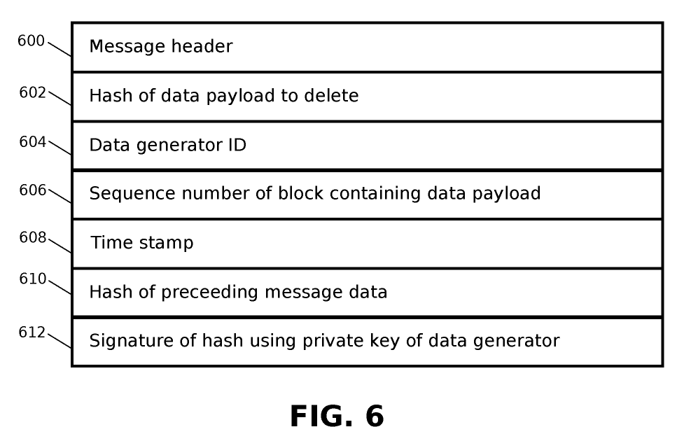

An embodiment of a request to delete is presented in FIG. 6, through which a network connected device 107 henceforth referred to as a “deleter” may request a deletion of a data payload.

The request to delete may comprise a header 600, which may comprise: an identifier indicating that the request to delete contains a request to delete the data payload, a size of the request to delete, a protocol for the deletion, a structure of other data comprising the request to delete.

The request to delete may comprise a hash of the data payload to be deleted 602.

The request to delete may comprise a data generator identifier 604, which in a preferred embodiment may comprise a public key of the data generator. The public key may comprise one of: an ECDSA public key, an ElGamal public key, an RSA public key, some other public key associated with an asymmetric key system.

The request to delete may comprise a sequence number 606 of a block containing the data payload and the hash of the data payload. Through the sequence number 606 participants on the peer-to-peer network maintaining the blockchain may quickly find the block containing the data payload and may delete it.

The request to delete may comprise a time stamp 608. In an embodiment the time stamp may comprise a time at which the request to delete was constructed. The request to delete may also comprise a plurality of time stamps.

The request to delete may comprise a hash 610 of all or part of a contents of the request to delete. The hash may be calculated using a cryptographic hash algorithm, for example: SHA, RIPEMD, Whirlpool, Scrypt, HAS-160, BLAKE, or other cryptographic hash function applied to all or part of the preceding content of the message, where a hash output cannot be determined from a hash input other than by an application of the cryptographic hash function to the hash input.

The request to delete may comprise a digital signature 612, generated with a digital signature algorithm using a private key associated with a public key of the deleter and with the hash 610, in order to provide for the veracity of the request to delete. The digital signature algorithm used may be one of ECDSA, DSA, RSA, or some other digital signing algorithm.

In some embodiments the digital signature 612 may comprise the public key of the deleter. The public key of the authorizer may be one of: an ECDSA public key, an ElGamal public key, an RSA public key, some other public key associated with an asymmetric key system.

Those skilled in the art will appreciate that embodiments above of the request to delete are examples of possible embodiments. In other embodiments, the request to delete may comprise elements in a different order, and each element may comprise further elements. In other embodiments the request to delete may be split into a plurality of parts, with the plurality of parts submitted to the blockchain in separate blocks.

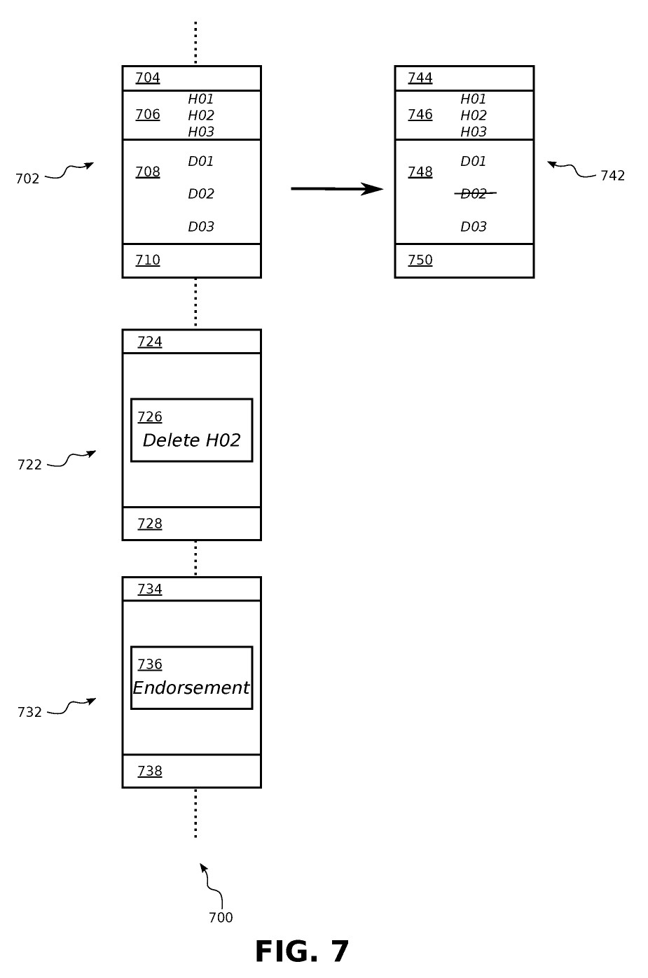

In FIG. 7 a diagram providing a possible embodiment of a method for deleting a data payload from the blockchain in response to a request to delete is presented.

In the embodiment a blockchain 700 may comprise a plurality of blocks. A first block 702 may comprise a first header 704, a list of one or more hashes of data payloads 706, a one or more data payloads 708 and a first hash 710 of the first header 704 and the list of one or more hashes of data payloads 706.

A second block 722 may comprise a second header 724, a request to delete 726 and a second hash 728 of the second header.

A third block 732 may comprise a third header 734, an endorsement 736 and a third hash of the third header 738.

In the embodiment a one or more participants maintaining the blockchain may detect the request to delete 726 and the endorsement 736, and may delete a data payload D02 of the one or more data payloads 708 corresponding to a data payload hash H02 contained in the list of one or more hashes of data payloads 706.

In the embodiment, as a result of a deletion of data payload D02, the first block 702 may be replaced within memory or storage of the one or more participants maintaining the blockchain, by a new block 742, comprising a new header 744 identical to the first header 704, a new list of one or more hashes of data payloads 746 identical to the list of one or more hashes of data payloads 706, a new one or more data payloads 748 that does not comprise the data payload D02, and a new hash 750 of the new header 744 and the new list of one or more hashes of data payloads 746, that is identical to the first hash 710.

In some embodiments, deletion of the data payload D02 may comprise a complete removal of all data comprising the data payload D02.

In some embodiments, deletion of the data payload D02 may comprise overwriting some or all data comprising the data payload D02 with zeros.

In some embodiments, deletion of the data payload D02 may comprise overwriting some or all data comprising the data payload D02 with a random data.

In some embodiments, deletion of the data payload D02 may comprise overwriting some or all data comprising the data payload D02 with a deletion message. The deletion message may comprise: the request to delete, a reference to the request to delete, an identity of a submitter of the request to delete, an IP address of a submitter of the request to delete, an email address of a submitter of the request to delete, a bank account number of a submitter of the request to delete, a cryptocurrency address of a submitter of the request to delete, a list of endorsements of the request to delete, a list of references to endorsements of the request to delete.

In an embodiment of the present disclosure, the list of references to endorsements of the request to delete may comprise a list of sequence numbers of a one or more blocks comprising the endorsements of the request to delete.

Those skilled in the art will appreciate that in the embodiment above, for illustrative purposes, a specific example of a possible embodiment has been presented. In other examples a number of blocks added to the blockchain may differ, and an order and number of a request to delete and of a one or more endorsements may differ, a creation and addition of blocks to the blockchain 700 may differ, and other actions and steps may be taken in a different order.

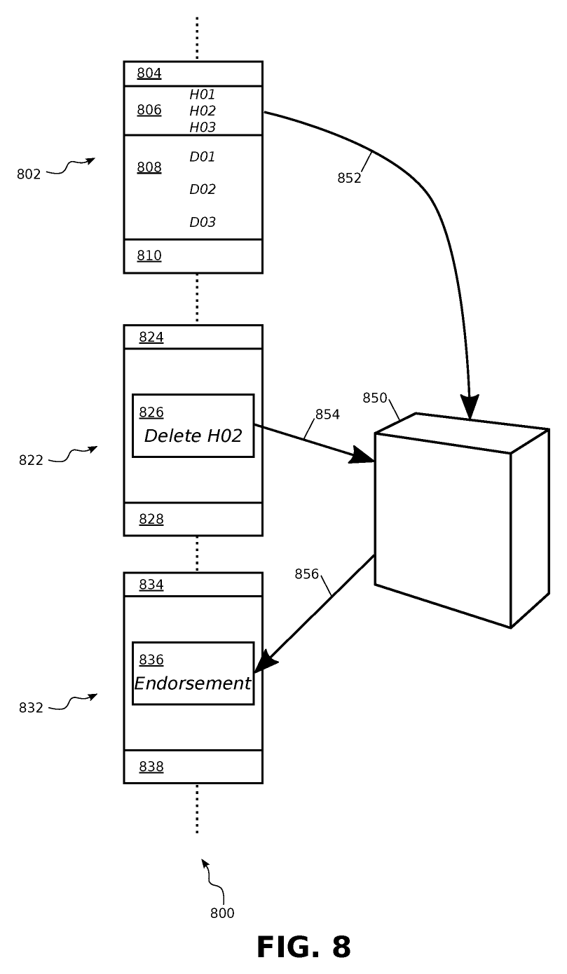

In FIG. 8 a diagram providing a possible embodiment of a process and system for endorsing the request to delete included in the blockchain is presented.

In the embodiment a blockchain 800 may comprise a plurality of blocks. A first block 802 may comprise a first header 804, a list of one or more hashes of data payloads 806, a one or more data payloads 808 and a first hash 810 computed from the first header 804 and the list of one or more hashes of data payloads 806.

A second block 822 may comprise a second header 824, a request to delete 826 and a second hash 828 of the second header.

A third block 832 may comprise a third header 834, an endorsement 836 and a third hash of the third header 838.

An endorser 850 participating on the blockchain 800 may determine a presence of the block 802 comprising the list of one or more hashes of data payloads 806, as shown in FIG. 8 by 852.

Subsequently the endorser 850 may determine a presence of the block 822 comprising the request to delete 826, as shown in FIG. 8 by 854.

The endorser 850 may then submit an endorsement 836 of the request to delete 826 to the blockchain 800 for inclusion in a block of the blockchain 800. In a present example provided for illustrative purposes under the current disclosure, the endorsement 836 may be included in the third block 832.

In some embodiments of the present disclosure, the endorsement 836 may comprise one or more of: a reference to the message to delete 826, an identifier of the endorser 850, a data identifying the endorsement 836 as an endorsement of a message to delete.

In some embodiments of the present disclosure, the identifier of the endorser 850 may comprise one or more of: a public key from a public/private key pair associated with the endorser 850, an identification number, an email address, an IP address.

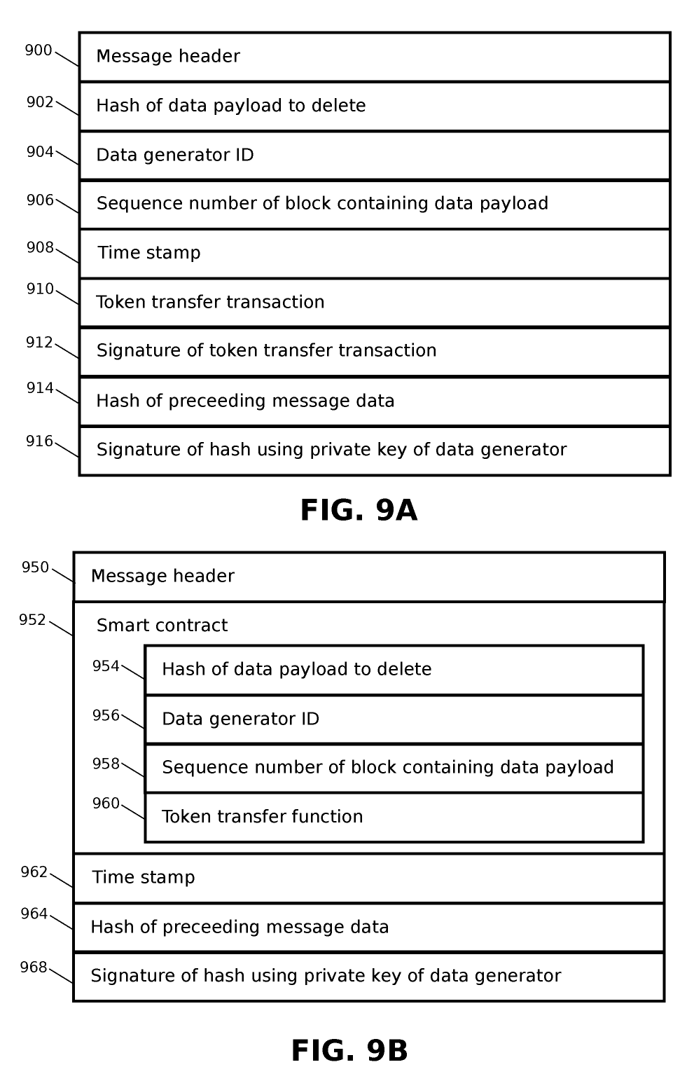

A request to delete with an associated cryptocurrency or token reward is presented in FIG. 9A, through which a request to delete a data payload may be embodied in a manner that provides participants on the blockchain with a portion of the cryptocurrency or token reward.

The request to delete may comprise a header 900, which may comprise: an identifier indicating that the request to delete contains a request to delete the data payload, a size of the request to delete, a protocol for the deletion, a structure of other data comprising the request to delete.

The request to delete may comprise a hash 902 of the data payload to be deleted.

The request to delete may comprise a data generator identifier 904, which in a preferred embodiment may comprise a public key of the data generator. The public key may comprise one of: an ECDSA public key, an ElGamal public key, an RSA public key, some other public key associated with an asymmetric key system.

The request to delete may comprise a sequence number 906 of a block containing the data payload and the hash 902 of the data payload. Through the sequence number 906 participants on the peer-to-peer network maintaining the blockchain may quickly find the block containing the data payload and may delete it.

The request to delete may comprise a time stamp 908. In an embodiment the time stamp may comprise a time at which the request to delete was constructed. The request to delete may also comprise a plurality of time stamps.

The request to delete may comprise a token transfer transaction 910, which in some embodiments may allow parties on the blockchain to claim a some or all of a quantity of tokens by complying with the request to delete.

The request to delete may comprise a digital signature 912 of the token transfer transaction 910, generated with a digital signature algorithm using a private key associated with a public key of a holder of a quantity of tokens, in order to provide for the veracity of the token transfer transaction. The digital signature algorithm used may be one of ECDSA, DSA, RSA, or some other digital signing algorithm.

The request to delete may comprise a hash 914 of all or part of a contents of the request to delete. The hash may be calculated using a cryptographic hash algorithm, for example: SHA, RIPEMD, Whirlpool, Scrypt, HAS-160, BLAKE, or other cryptographic hash function applied to all or part of the preceding content of the message, where a hash output cannot be determined from a hash input other than by an application of the cryptographic hash function to the hash input.

The request to delete may comprise a digital signature 916, generated with a digital signature algorithm using a private key associated with a public key of the deleter and with the hash 914, in order to provide for the veracity of the request to delete. The digital signature algorithm used may be one of ECDSA, DSA, RSA, or some other digital signing algorithm.

In some embodiments the digital signature 916 may comprise the public key of the deleter. The public key of the authorizer may be one of: an ECDSA public key, an ElGamal public key, an RSA public key, some other public key associated with an asymmetric key system.

An alternate embodiment of a request to delete, with an associated cryptocurrency or token reward, is presented in FIG. 9B, through which a request to delete a data payload may be embodied in a manner that provides participants on the blockchain with a some of the cryptocurrency or token reward through an execution of a smart contract, which in some embodiments may comprise a section of computer code executed on the blockchain.

In some embodiments the section of computer code may transfer an existing quantity of tokens to recipients determined from an input to the smart contract. The input may comprise data extracted from prior or subsequent blocks of the blockchain.

In other embodiments the section of computer code may instantiate a quantity of tokens, which subsequently may be transferred to recipients, as determined from an input to the smart contract. The input may comprise data extracted from prior or subsequent blocks of the blockchain.

The request to delete may comprise a header 950, which may comprise: an identifier indicating that the request to delete contains a request to delete the data payload, a size of the request to delete, a protocol for the deletion, a structure of other data comprising the request to delete.

The request to delete may comprise a smart contract 952.

The smart contract 952 may comprise a hash 954 of a data payload to delete.

The smart contract may comprise a data generator identifier 956, which in a preferred embodiment may comprise a public key of the data generator. The public key may comprise one of: an ECDSA public key, an ElGamal public key, an RSA public key, some other public key associated with an asymmetric key system.

The smart contract may comprise a sequence number 958 of a block containing the data payload and the hash 954 of the data payload. Through the sequence number 958, participants on the peer-to-peer network maintaining the blockchain may quickly find the block containing the data payload and may delete it.

The smart contract may comprise a token transfer function 960. In some embodiments the token transfer function 960 may specify conditions under which parties participating in maintaining and extending the blockchain may claim a some or all of a quantity of tokens native to the blockchain by complying with the request to delete. In other embodiments, the quantity of tokens may be instantiated and transferred by the token function 960, for example but not limited to, through an implementation of an ERC20 standard on an Ethereum blockchain, or through some other token standard.

The request to delete may comprise a time stamp 962. In an embodiment the time stamp may comprise a time at which the request to delete was constructed. The request to delete may also comprise a plurality of time stamps.

The request to delete may comprise a hash 964 of all or part of a contents of the request to delete. The hash may be calculated using a cryptographic hash algorithm, for example: SHA, RIPEMD, Whirlpool, Scrypt, HAS-160, BLAKE, or other cryptographic hash function applied to all or part of the preceding content of the message, where a hash output cannot be determined from a hash input other than by an application of the cryptographic hash function to the hash input.

The request to delete may comprise a digital signature 968, generated with a digital signature algorithm using a private key associated with a public key of the deleter and with the hash 964, in order to provide for the veracity of the request to delete. The digital signature algorithm used may be one of ECDSA, DSA, RSA, or some other digital signing algorithm.

In some embodiments the digital signature 968 may comprise the public key of the deleter. The public key of the deleter may be one of: an ECDSA public key, an ElGamal public key, an RSA public key, some other public key associated with an asymmetric key system.

In some embodiments of the present disclosure, the token transfer transaction 910 may transfer tokens to an endorser of the request to delete.

In some embodiments of the present disclosure, the smart contract 952 may transfer tokens to an endorser of the request to delete.

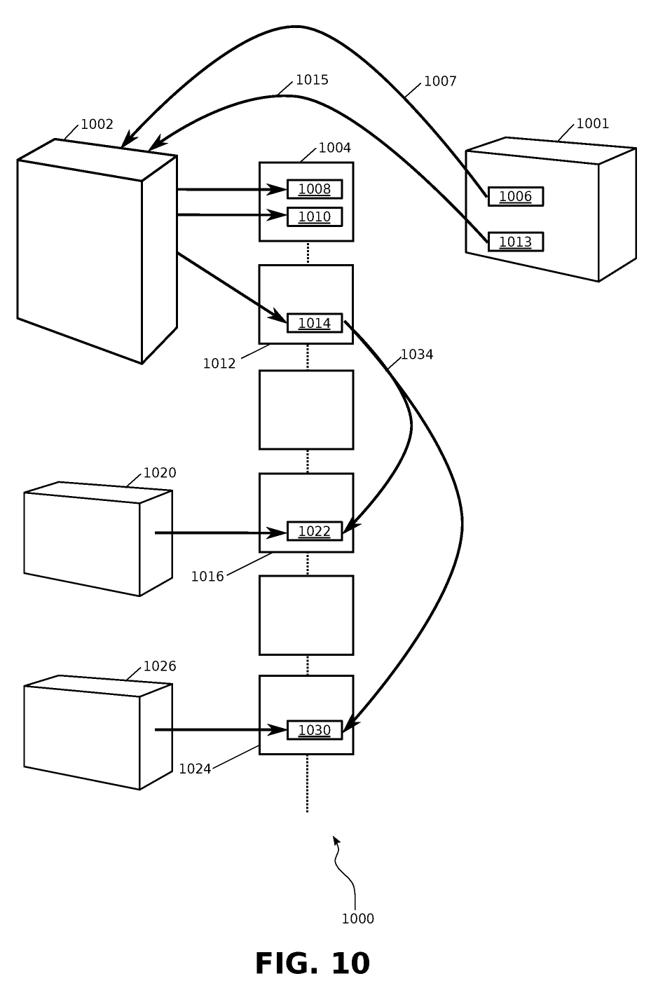

In FIG. 10 a process and apparatus for transferring a portion of a quantity of the tokens, associated with a request to delete, to an endorser, is presented, in accordance with an embodiment of the present disclosure.

Operations may commence by a data generator 1001 submitting a data payload 1006 to a blockchain 1000, for example, through a transaction message 1007 to a validator 1002 operating on the blockchain 1000.

In some embodiments the validator 1002 may calculate a hash 1008 of the data payload 1006, construct a block 1004 comprising the hash 1008 and a copy of the data payload 1010, and submit the block 1004 for inclusion on the blockchain 1000. In other embodiments the data generator 1001 may also comprise the validator 1002.

The data generator 1001 may submit an initial request to delete 1013, which in some embodiments may be received and copied by a validator 1002, producing a request to delete 1014. A submission of the initial request to delete 1013 is indicated in FIG. 10 by 1015.

Said request to delete 1014 may be included in a block 1012 by a validator 1002, said block 1012 submitted for inclusion on the blockchain 1000.

The request to delete 1013 may comprise a transaction to transfer a portion of a quantity of tokens to an endorser of the request to delete 1013.

In some other embodiments the request to delete 1013 may comprise a smart contract to transfer a portion of a quantity of tokens to an endorser of the request to delete 1013.

In some embodiments a first endorser 1020 may submit a first endorsement 1022 for inclusion on the blockchain. In an embodiment the first endorser 1020 may comprise a validator, packaging the first endorsement 1022 in a block 1016 for inclusion on the blockchain 1000.

In some embodiments a second endorser 1026 may submit a second endorsement 1030 for inclusion on the blockchain. In an embodiment the second endorser 1026 may comprise a validator, said validator packaging the second endorsement 1030 in a block 1024 for inclusion on the blockchain 1000.

In some embodiments, an inclusion of an endorsement on the blockchain 1000 may result in or equate to a transfer of a portion of a quantity of tokens from an address or wallet specified in the request to delete 1014 to an address or wallet specified in the endorsement, through execution of the transaction. In some embodiments the transaction may comprise a native cryptocurrency transfer transaction. In other embodiments the transaction may comprise a smart contract.

In the example above, the portion may comprise a half of the quantity of tokens. The half of the quantity of tokens may be transferred to the first endorser 1020, and an other half of the quantity of tokens may be transferred to the second endorser 1026.

A transfer of tokens is indicated in FIG. 10 by 1034.

In other embodiments there may be a different numbers of endorsers, and the portion may comprise a different proportion of the quantity of tokens.

In other embodiments, a size of the portion may decrease or increase proportionally to a time between inclusion of the request to delete 1014 and an endorsement.

In yet another embodiment, the size of the portion may decrease or increase proportionally to a number of blocks between the block 1012 including the request to delete 1014 and a block including an endorsement.

In a further embodiment, the time or the number of blocks may have a cut-off value, under which endorsements submitted after the cut-off value may not receive any tokens from the transaction.

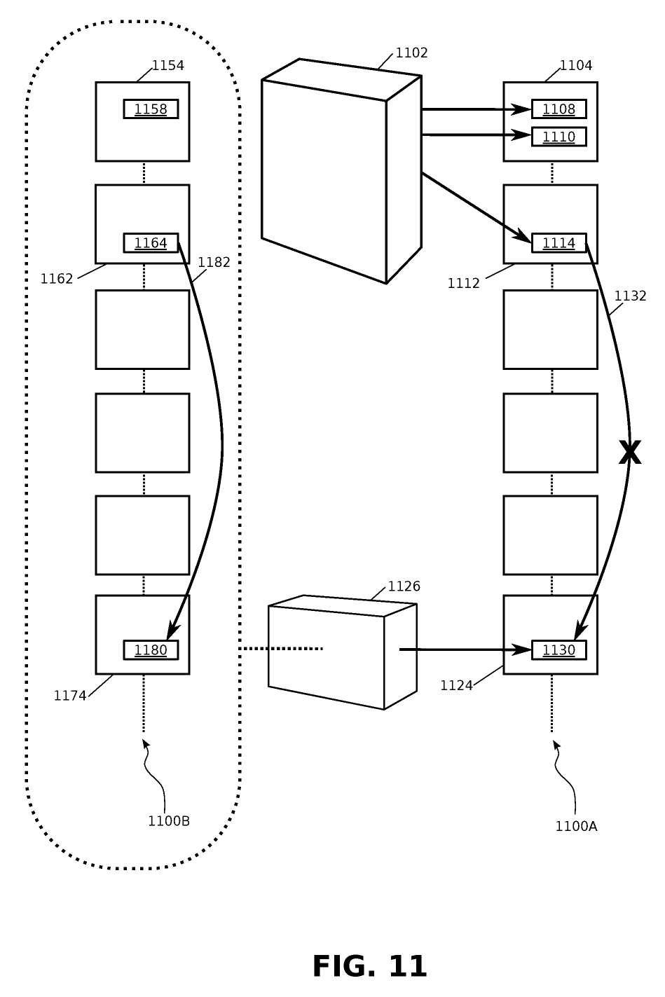

In FIG. 11 a process and apparatus are presented, for transferring a portion of a quantity of tokens, associated with a request to delete, to a deleter, in accordance with an embodiment of the present disclosure.

For purposes of clarity, a role of data generator and validator embodied in a single network connected device 1102 is presented. However, those skilled in the art will appreciate from the teachings of FIG. 10 that in an other embodiment of the present disclosure the process and apparatus may comprise a separate validator and a separate data generator.

Operations may commence by the network connected device 1102 submitting a data payload 1110 to a blockchain 1100A. In some embodiments the network connected device 1102 may calculate a hash 1108 of the data payload 1110, construct a block 1104 comprising the hash 1108 and the data payload 1110, and submit the block 1104 for inclusion on the blockchain 1100A.

The network connected device 1102 may submit a request to delete 1114 to the blockchain 1100A. The request to delete 1114 may be included in a block 1112 by the network connected device 1102, said block 1112 submitted for inclusion on the blockchain 1100A.

The request to delete 1114 may comprise a smart contract configured to transfer a portion of a quantity of tokens to entities deleting the data payload 1110.

In some embodiments a deleter 1126 may submit an acknowledgement of deletion 1130 to the blockchain 1100A, which may be included in a later block 1124 for inclusion on the blockchain 1100A.

In some embodiments the acknowledgement of deletion 1130 may comprise one or more of: a wallet, a token address, an identifier of the deleter 1126. For the purposes of this disclosure we shall refer to any of these embodiments of the acknowledgement of deletion 1130 as comprising “a token address”, nevertheless this should not be interpreted as a limitation to these embodiments, and “a token address” may also be read as “a wallet”, or as “an identifier of the deleter 1126”.

In some embodiments, the request to delete 1114 may detect the acknowledgement of deletion 1130 and may examine the blockchain 1100A to determine if the data payload 1110 has been deleted.

The request to delete 1114 may determine that the data payload 1110 has not been deleted, and no transfer of the portion of a quantity of tokens to the token address of the deleter 1126 may occur, as indicated in FIG. 11 by 1132.

Those skilled in the art will appreciate that copies of a blockchain may reside in a memory or a digital storage of some or all of a plurality of participants on the blockchain, and that systems and methods of the blockchain provide a means for ensuring each of the copies of the blockchain are in effect identical, through a set of rewards and penalties embodied in a consensus system of the blockchain.

In some embodiments, a blockchain 1100B comprising a near copy of the blockchain 1100A may reside in a memory or other digital storage of the deleter 1126.

In said blockchain 1100B, in an embodiment of the present disclosure, a hash 1158 may comprise a copy of the hash 1108, a block 1154 may comprise a copy of the block 1104, a request to delete 1164 may comprise a copy of the request to delete 1114, a block 1162 may comprise a copy of the block 1112, a block 1174 may comprise a copy of the block 1124 and an acknowledgement of deletion 1180 may comprise a copy of the acknowledgement of deletion 1130.

The request to delete 1164 may determine that the data payload 1110 is not present in the blockchain 1100B, and may transfer the portion of a quantity of tokens to the token address of the deleter 1126, as indicated in FIG. 11 by 1182.

Through the above, in some embodiments of the present disclosure, all participants on a blockchain may store data comprising the blockchain 1100B in preference to data comprising blockchain 1100A, resulting in an effective deletion of the data payload 1110.

The technology described herein is operational with numerous other general purpose or special purpose computing system environments or configurations. Examples of well-known computing systems, environments, and/or configurations that may be suitable for use with the disclosure include, but are not limited to, personal computers, server computers, hand-held or laptop devices, multiprocessor systems, processor-based systems, programmable consumer electronics, network PCs, minicomputers, mainframe computers, distributed computing environments that include any of the above systems or devices, and the like.

As used herein, instructions refer to computer-implemented steps for processing information in the system. Instructions can be implemented in software, firmware or hardware and include any type of programmed step undertaken by components of the system.

A processor may be any conventional general purpose single- or multi-chip processor such as a Pentium® processor, a Pentium® Pro processor, a 8051 processor, a MIPS® processor, a Power PC® processor, or an Alpha® processor. In addition, the processor may be any conventional special purpose processor such as a digital signal processor or a graphics processor. The processor typically has conventional address lines, conventional data lines, and one or more conventional control lines.

The system is comprised of various modules as discussed in detail. As can be appreciated by one of ordinary skill in the art, each of the modules comprises various sub-routines, procedures, definitional statements and macros. Each of the modules are typically separately compiled and linked into a single executable program. Therefore, the description of each of the modules is used for convenience to describe the functionality of the preferred system. Thus, the processes that are undergone by each of the modules may be arbitrarily redistributed to one of the other modules, combined together in a single module, or made available in, for example, a shareable dynamic-link library.

The system may be used in connection with various operating systems such as Linux®, UNIX® or Microsoft Windows®.

The system may be written in any conventional programming language such as C, C++, Pascal, or Java, and ran under a conventional operating system. C, C++, Pascal, Java, and FORTRAN are industry standard programming languages for which many commercial compilers can be used to create executable code. The system may also be written using interpreted languages such as Perl, Python or Ruby, or languages that may either be compiled or interpreted, such as BASIC or Lisp.

Those of skill will further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the embodiments disclosed herein may be implemented or performed with a general purpose processor, a DSP, an ASIC, an FPGA or other programmable logic device, discrete gate or transistor logic, discrete hardware components, or any combination thereof designed to perform the functions described herein. A general purpose processor may be a microprocessor, but in the alternative, the processor may be any conventional processor, controller, micro-controller, or state machine. A processor may also be implemented as a combination of computing devices, e.g., a combination of a DSP and a microprocessor, a plurality of microprocessors, one or more microprocessors in conjunction with a DSP core, or any other such configuration.

In one or more example embodiments, the functions and methods described may be implemented in hardware, software, or firmware executed on a processor, or any combination thereof. If implemented in software, the functions may be stored on or transmitted over as one or more instructions or code on a computer-readable medium. Computer-readable media include both computer storage media and communication media including any medium that facilitates transfer of a computer program from one place to another. A storage medium may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

In one or more example embodiments, reference is made to an identifier of a participant in the system. It will be appreciated that said identifier may comprise a public key of a public/private key pair associated with an asymmetric key cryptography system. Under other systems, said identifier may comprise a transformation of said public key through an application of a one or more hash functions or transformative functions such that a resulting identifier is distinct from the public key and yet only the public key may generate the identifier through an application of the transformation. As such, where “a public key” is specified in the present disclosure this may equally be read as an identifier generated from the transformation.

The foregoing description details certain embodiments of the systems, devices, and methods disclosed herein. It will be appreciated, however, that no matter how detailed the foregoing appears in text, the systems, devices, and methods can be practiced in many ways. As is also stated above, it should be noted that the use of particular terminology when describing certain features or aspects of the disclosure should not be taken to imply that the terminology is being re-defined herein to be restricted to including any specific characteristics of the features or aspects of the technology with which that terminology is associated.

It will be appreciated by those skilled in the art that various modifications and changes may be made without departing from the scope of the described technology. Such modifications and changes are intended to fall within the scope of the embodiments. It will also be appreciated by those of skill in the art that parts included in one embodiment are interchangeable with other embodiments; one or more parts from a depicted embodiment can be included with other depicted embodiments in any combination. For example, any of the various components described herein and/or depicted in the Figures may be combined, interchanged or excluded from other embodiments.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

While various aspects and embodiments have been disclosed herein, other aspects and embodiments will be apparent to those skilled in the art. The various aspects and embodiments disclosed herein are for purposes of illustration and are not intended to be limiting.

As will be appreciated from the above discussion, a system and method is presented for adding and subsequently deleting a data payload from a blockchain, wherein consensus is obtained on the blockchain through a consensus protocol and optionally through a use of smart contracts to provide an incentive to act on a request to delete.

What is claimed is:

1. A method for adding and subsequently deleting data from a blockchain, comprising:
constructing a block of data for the blockchain comprising: a first portion of the block of data comprising a list of hashes of a one or more data payloads, a second portion of the block of data comprising the one or more data payloads, and a hash of a first portion of a prior block of data from the blockchain; and
including the block of data in the blockchain; and
transmitting to the blockchain, at a later time, a request to delete a one or more of the one or more data payloads; and
deleting from the blockchain the one or more of the one or more data payloads.

2. The method of claim 1, wherein the one or more of the one or more data payloads are deleted from the blockchain by overwriting the one or more of the one or more data payloads with one or more of: zeros, random data, a deletion message, an other data.

3. The method of claim 1, further comprising:
submitting an endorsement of the request to delete; and
deleting from the blockchain the one or more of the one or more data payloads if a number of endorsements of the request to delete is equal to or greater than a predetermined number.

4. The method of claim 3, further comprising forgoing a submission of the endorsement of the request to delete on determining that the request to delete was not made by an authorized entity.

5. The method of claim 3, further comprising: associating the request to delete with a quantity of tokens, such that said quantity of tokens is claimed on submitting the endorsement of the request to delete.

6. The method of claim 3, further comprising: associating the request to delete with a quantity of tokens, such that said quantity of tokens is claimed on deleting from the blockchain the one or more of the one or more data payloads.

7. A plurality of network connected devices, each comprising: one or more processors, and storage media comprising computer instructions, said plurality of network connected devices being connectible via a network to each other, arranged such that when computer instructions are executed on the one or more processors of a one or more of the plurality of network connected devices, operations are caused for adding and subsequently deleting data from a blockchain, comprising:
constructing, by a first network connected device, a block of data for the blockchain comprising: a first portion of the block of data comprising a list of hashes of a one or more data payloads, a second portion of the block of data comprising the one or more data payloads, and a hash of a first portion of a prior block of data from the blockchain; and
including the block of data in the blockchain, by the plurality of network connected devices; and
transmitting to the blockchain, at a later time, by a second network connected device, a request to delete a one or more of the one or more data payloads; and
deleting from the blockchain, by the plurality of network connected devices, the one or more of the one or more data payloads.

8. The plurality of network connected devices of claim 7, wherein the one or more data payloads are deleted from the blockchain, by the plurality of network connected devices, by overwriting the data payloads with one or more of: zeros, random data, a deletion message, an other data.

9. The plurality of network connected devices of claim 7, further comprising:
submitting, by a one or more of the plurality of network connected devices, an endorsement of the request to delete; and
deleting from the blockchain, by the plurality of network connected devices, the one or more of the one or more data payloads, if a number of endorsements of the request to delete is equal to or greater than a predetermined number.

10. The plurality of network connected devices of claim 9, further comprising forgoing submitting the endorsement of the request to delete, by the plurality of network connected devices, on determining that the second of the plurality of network connected devices is not an authorized entity.

11. The plurality of network connected devices of claim 9, further comprising: associating, by the second of the network connected devices, the request to delete with a quantity of tokens, such that said quantity of tokens is claimed by the plurality of network connected devices on submitting the endorsement of the request to delete.

12. The plurality of network connected devices of claim 9, further comprising: associating, by the second of the network connected devices, the request to delete with a quantity of tokens, such that said quantity of tokens is claimed by the plurality of network connected devices on deleting from the blockchain the one or more of the one or more data payloads.
